(19) United States
(12) Patent Application Publication
(10) Pub. No.: US 2016/0201724 A1
(43) Pub. Date: Jul. 14, 2016

(54) ROLLING BEARING ASSEMBLY FOR TURBOCHARGERS AND METHOD FOR INSTALLING A ROLLING BEARING ASSEMBLY

(71) Applicant: SCHAEFFLER TECHNOLOGIES AG & CO. KG, Herzogenaurach (DE)

(72) Inventors: Christoph Ross, Stegaurauch (DE); Klaus Daut, Herzogenaurach (DE)

(21) Appl. No.: 14/910,907

(22) PCT Filed: May 27, 2014
(86) PCT No.: PCT/DE2014/200237

§ 371 Date: Feb. 8, 2016

(30) Foreign Application Priority Data
Aug. 8, 2013 (DE) 10 2013 215 619.7

(51) Int. Cl. F16C 33/60; F16C 35/063

(52) U.S. Cl. CPC F16C 33/60; F16C 35/063

(57) ABSTRACT

The invention relates to a rolling-element bearing device (1) for turbochargers and to a method for installing a rolling-element bearing device. The rolling-element bearing device, while in operation, surrounds a rotor shaft (20) supported by a bearing (10). A first cage (4) and a second cage (5) are used to accommodate rolling elements (7) and each run between an inner raceway (21, 22) and a correspondingly associated outer raceway (11).

The present invention relates to a rolling bearing assembly for turbochargers. In particular, the rolling bearing assembly includes a bearing and a rotor shaft. The rotor shaft has a first inner raceway and a second inner raceway provided for the bearing. A first cage and a second cage are provided for accommodating rolling elements. A first outer ring and a second outer ring, each having an outer raceway, are furthermore provided. The rolling elements roll between the first inner raceway or the second inner raceway and the particular outer raceway.

The present invention furthermore relates to a method for installing a rolling bearing assembly.

### BACKGROUND

Turbochargers for passenger car applications are usually designed with a rotor shaft which is supported radially by two friction bearings. In truck applications, rolling bearing assemblies are used in individual cases. The use of rolling bearing assemblies in truck applications is possible due to the low rotational speeds which occur here.

According to the present prior art, a rolling bearing assembly in turbochargers is a unit in which two rolling bearings are combined in the form of a so-called cartridge. This design is presently preferred, due to the ease with which this system may be integrated into existing customer applications. In particular, materials, e.g., M50 from the field of aerospace engineering, are used to be able to safely meet the high thermal requirements.

All components are usually assembled by the supplier of the turbocharger, who purchases them from sub-suppliers. These include the shaft, the turbine and compressor wheels, the friction bearings or rolling bearing units as well as all other components. Therefore, this results in a high risk or high complexity for the turbocharger producer in coordinating the different suppliers' components. The customer then installs the fully assembled bearing unit onto the turbine shaft and then installs it in the bearing housing later on.

The German patent application DE 10 2010 054 939 A1 discloses a bearing system for a turbocharger. The bearing system for a turbocharger includes a bearing housing which extends in the axial direction. A rolling bearing, which includes an outer bearing ring and a plurality of rolling elements, is situated within the bearing housing. A shaft, which extends axially, is rotatably supported within the bearing housing. The shaft itself is provided with a rolling element raceway (inner raceway).

### SUMMARY OF THE INVENTION

It is an object of the present invention to reduce the manufacturing costs for a turbocharger which includes a rolling bearing-supported rotor shaft. In addition, the installation space for the rolling bearing-supported rolling bearing assembly is reduced, and all advantages of a rolling bearing assembly in turbochargers are simultaneously guaranteed.

It is an alternate or additional object of the present invention to provide a method so that the installation of a rolling bearing assembly may be cost-effectively carried out in a reduced installation space, it being possible to supply the rolling bearing assembly to a customer in the form of a finished unit.

The present invention provides a-rolling bearing assembly for turbochargers, including a bearing and a rotor shaft as well as a first cage and a second cage for accommodating rolling elements. A first outer ring and a second outer ring, each having an outer raceway, are also assigned to the rotor shaft. A first inner raceway and a second inner raceway are provided for the bearing in the rotor shaft.

A claw-shaped formation is provided on the first outer ring and on the second outer ring, so that the first outer ring and the second outer ring are held against each other in a form-fitting manner, comparable to a claw coupling. These claw-shaped formations interact in the assembled state of the bearing in such a way that a clearance is provided, which is open toward the rotor shaft. This clearance is used for an oil return.

During the manufacture of a rotor shaft of a turbocharger, the first inner raceway and the second inner raceway are provided, each of which is used to accommodate the rolling elements. Due to the formation of the first inner raceway and the second inner raceway, the separate inner rings for supporting the rotor shaft may be dispensed with. The rotor shaft thus no longer has to be ground over its entire surface. In this case, it is sufficient to grind the first inner raceway and the second inner raceway, the axial starting point, the compressor wheel seat and the position of the turbine wheel to be welded on at a later time.

The first outer ring and the second outer ring of the bearing are recessed, as in a claw coupling. Each of the two outer rings is provided with an identical outer raceway for the rolling elements. The first and second outer rings are situated in a mirrored manner on the rotor shaft and are absolutely identical. The relation between the two bearing points takes place via the rotor shaft, which is a single piece in any case and which is subject to extremely high accuracy requirements, the two inner raceways of the rolling bearing assembly being introduced into the rotor shaft.

A gap is provided between the first outer ring and the second outer ring. A securing element is mounted in this gap, whereby the bearing play and the position of the first outer ring and the second outer ring may be adjusted with respect to each other in the direction of the axis of the rotor shaft.

The securing element also secures the first outer ring and the second outer ring against rotation and connects the two outer rings to each other in a form-fitting manner. The adjustment takes place in that the clamps are manufactured with different material or sheet metal thicknesses, and the securing element is then mounted in a gap between the first outer ring and the second outer ring, which forms in the assembled state of the bearing. A tab of the securing element is situated in the gap between the first outer ring and the second outer ring. According to one possible specific embodiment, the securing element may be manufactured from sheet metal and thus be designed as a sheet-metal clamp.

According to the prior art, the securing against rotation may also take place with the aid of a width flat on the outer diameter, against which a screw then presses, which, in turn, is screwed into a housing.

Heat choke grooves are provided on the end of the rotor shaft facing the turbine wheel. They make it possible to accommodate a two-part cover sheet in the customer's welding machine. The cover sheet engages with this groove during the welding operation and thus prevents the penetration of contamination and spatters during the welding operation on the customer's premises. In this way, it is possible to carry out the further processing with the bearing and also to deliver the unit, together with the turbine housing, to the customer.

In the method for installing a rolling bearing assembly, a first cage, including rolling elements, is initially mounted on a first inner raceway provided in a rotor shaft. The first outer ring is subsequently installed in such a way that the rolling elements of the first cage interact with the first inner raceway and an outer raceway of the first outer ring. A second outer ring is then installed on the rotor shaft, the first outer ring and the second outer ring partially meshing with each other axially. Subsequently, a second cage, including rolling elements, is placed on a second inner raceway provided in the rotor shaft. Finally, the second outer ring is pulled out with respect to the first outer ring and rotated, so that the claw-shaped formations of the first outer ring and the second outer ring connect to each other in a form-fitting manner.

To establish a secure hold between the first outer ring and the second outer ring, a securing element is mounted in a gap between the first outer ring and the second outer ring. As mentioned above, it is possible to adjust the bearing play and the position of the first outer ring and the second outer ring in the direction of axis A of the rotor shaft with the aid of the securing element.

### BRIEF DESCRIPTION OF THE DRAWINGS

Exemplary embodiments of the present invention and their advantages are explained in greater detail below on the basis of the attached figures. The proportions in the figures do not always correspond to the real proportions, since some shapes have been simplified and other shapes have been enlarged in relation to other elements for the purpose of better illustration.

FIG. 1 shows a schematic representation of a rotor shaft for a friction bearing according to the prior art;

FIG. 2 shows a schematic representation of a rotor shaft according to the present invention, including inner raceways for rolling elements provided on the rotor shaft;

FIG. 3 shows a schematic representation of a rotor shaft, with the first cage and the first outer ring installed;

FIG. 4 shows a schematic representation of a rotor shaft, with the first cage, the first outer ring and the second outer ring installed

FIG. 5 shows a schematic representation of a rotor shaft, with the first cage, the second cage, the first outer ring and the second outer ring installed;

FIG. 6 shows a schematic representation, in which the first outer ring and the second outer ring are situated in the end position and are held against each other in a form-fitting manner;

FIG. 7 shows a schematic representation of a rolling bearing assembly, which includes the rotor shaft and the bearing;

FIG. 8A shows a sectional view of the securing element along the axis of the rotor shaft; and

FIG. 8B shows a view of the securing element from the direction of the axis of the rotor shaft.

### DETAILED DESCRIPTION

Identical reference numerals are used for the same elements or elements having the same function. Furthermore, for the sake of clarity, only reference numerals which are necessary for describing the particular figure are shown in the individual figures. The illustrated specific embodiments are only examples of how the rolling bearing assembly according to the present invention may be designed, or how the method according to the present invention for manufacturing a rolling bearing assembly is constituted.

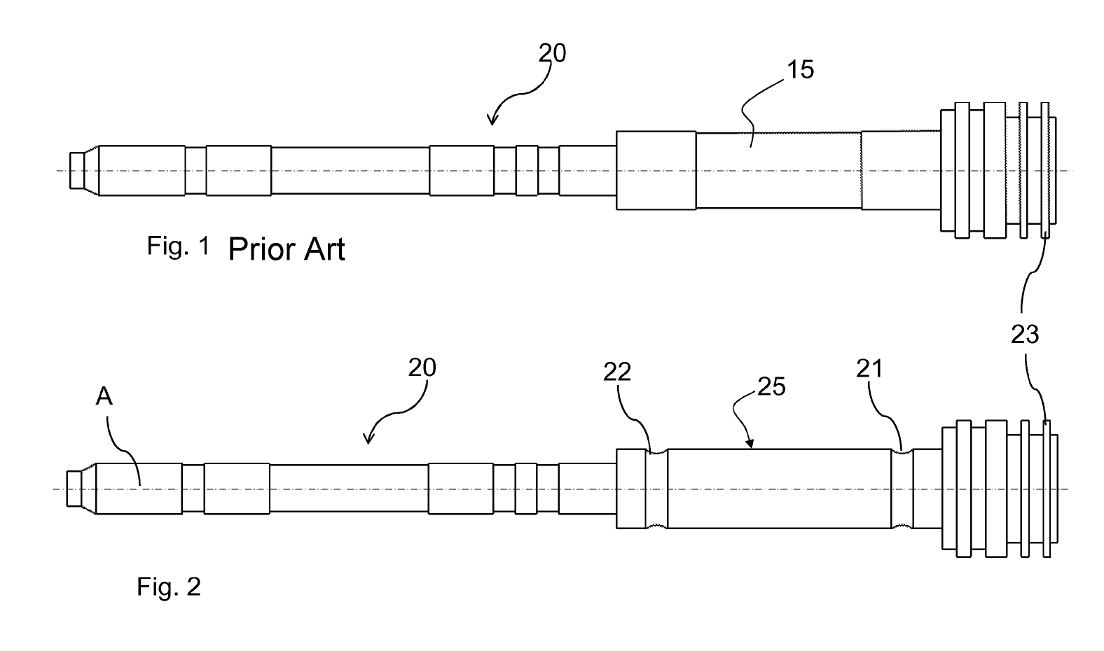

FIG. 1 shows a rotor shaft 20, including a friction bearing 15, according to the prior art. A heat choke groove 23 is provided on the end of rotor shaft 20 following friction bearing 15.

FIG. 2 shows a schematic representation of rotor shaft 20 designed according to the present invention. Rotor shaft 20 has a first inner raceway 21 and a second inner raceway 22 integrated into one area. A plunge-cut grinding method is used in the manufacture of rotor shaft 20, due to the necessary accuracies. First inner raceway 21 and second inner raceway 22 are provided on rotor shaft 20 during the plunge-cut grinding method. Heat choke groove 23 abuts area 25, in which first inner raceway 21 and second inner raceway 22 are provided.

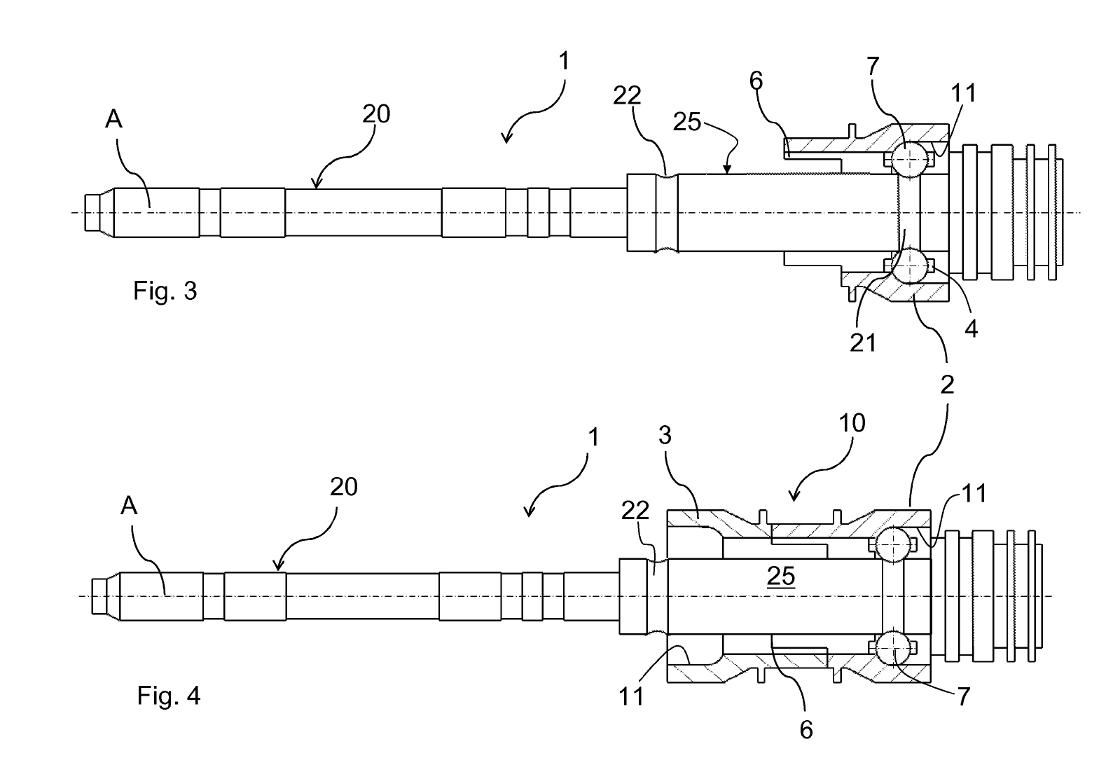

FIG. 3 shows a schematic representation of rolling bearing assembly 1, in which first outer ring 2 is already mounted on rotor shaft 20. Likewise, a first cage 4, including rolling elements 7, is provided, which is situated in such a way that rolling elements 7 of first cage 4 interact with first inner raceway 21 and outer raceway 11 provided on first outer ring 2. First outer ring 2 is provided with at least one claw-shaped formation 6, which is oriented in the direction of axis A of rotor shaft 20.

FIG. 4 shows a view of rolling bearing assembly 1, in which, in addition to first outer ring 2, second outer ring 3 is mounted on area 25 of rotor shaft 20. First outer ring 2 and second outer ring 3 are meshed with each other in such a way that second inner raceway 22 of the rotor shaft is accessible.

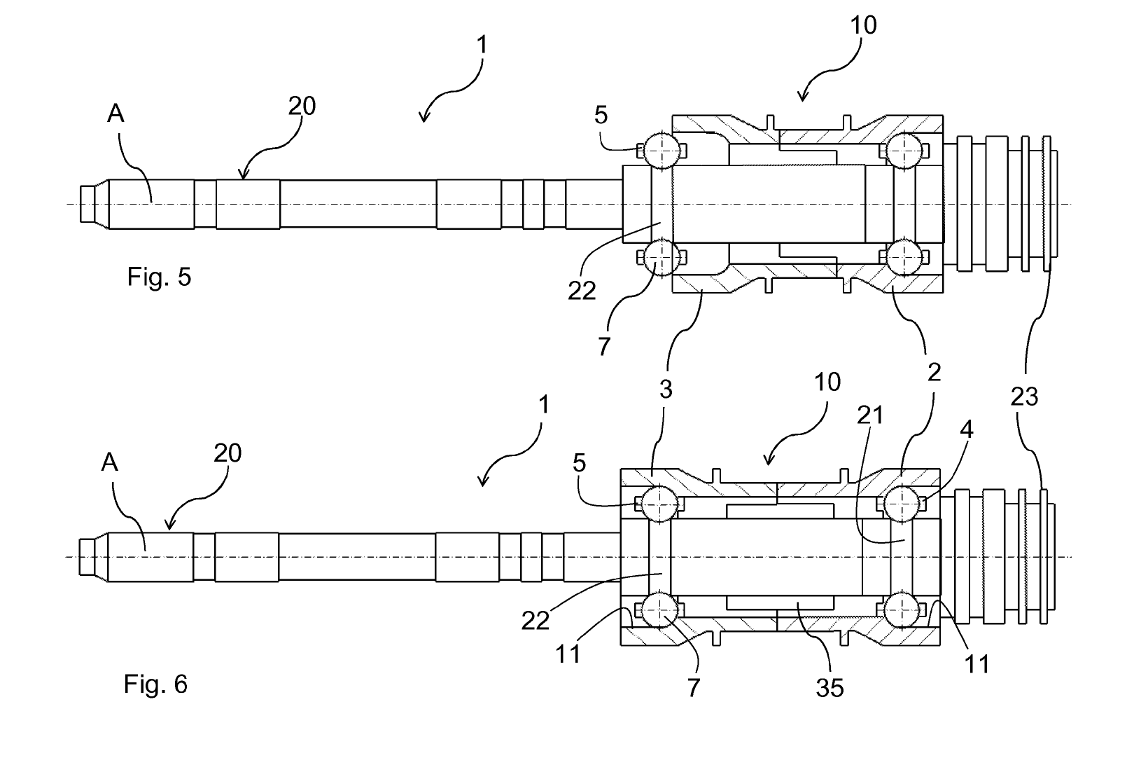

FIG. 5 shows the representation of rolling bearing assembly 1, in which a second cage 5, including rolling elements 7, which are preferably designed as balls, is introduced into second inner raceway 22 of rolling bearing 20. A bearing 10 is thus formed due to the arrangement of first outer ring 2 and second outer ring 3 on rotor shaft 20.

FIG. 6 shows the arrangement in which first outer ring 2 and second outer ring 3 of bearing 10 are rotated with respect to each other and pulled apart. By rotating and pulling apart first outer ring 2 and second outer ring 3, a clearance 35 is formed, which is open in the direction of area 25 of rotor shaft 20. Clearances 35 created thereby are used for an oil return. Due to the positioning, which takes place by pulling out and subsequently rotating second outer ring 3 with respect to first outer ring 2, rolling elements 7 of second cage 5 thus abut second inner raceway 22 and outer raceway 11 of second outer ring 3.

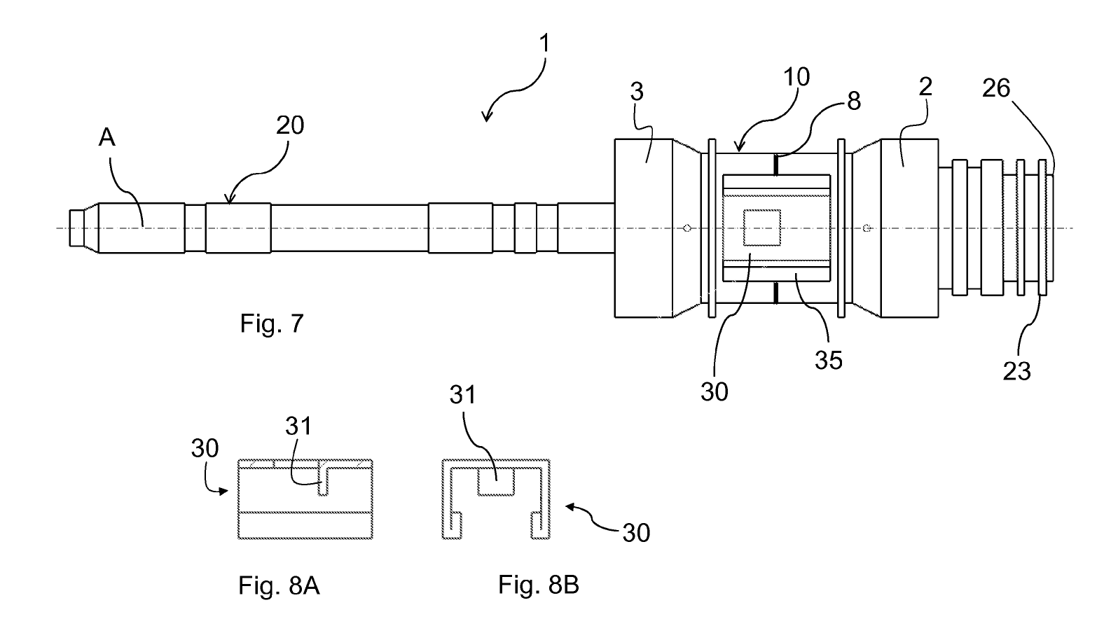

FIG. 7 shows a schematic representation of rolling bearing assembly 1, in which first outer ring 2 and second outer ring 3 are already installed on rotor shaft 20. Bearing 10 is thus formed from first outer ring 2 and second outer ring 3. First outer ring 2 and second outer ring 3 are held together by a securing element 30 (see FIG. 8A and FIG. 8B) in the assembled state on rotor shaft 20.

As illustrated in FIG. 8A and FIG. 8B, securing element 30 includes a tab 31. This tab 31 engages with a gap 8 between first outer ring 2 and second outer ring 3. Due to the securing element, a rotation with respect to first outer ring 2 and second outer ring 3 is prevented. Securing element 30 is ideally manufactured from sheet metal with the aid of a forming process. By manufacturing securing elements 30 which have different sheet thicknesses (material thicknesses), it is possible to sufficiently accurately adjust the play of bearing 10. In addition, first outer ring 2 and second outer ring 3 are held in position with respect to each other by the securing element. As mentioned above, a length adjustment between first inner raceway 21 and second inner raceway 22 may be established by using a suitable securing element having a corresponding material thickness. As is apparent from FIG. 7, a heat choke groove 23 abuts bearing 10. Heat choke groove 23 is provided on end 26 of the rotor shaft facing the turbine wheel. Heat choke groove 23 makes it possible to accommodate a two-part cover sheet in the customer's welding machine. The cover sheet engages with heat choke groove 23 during the welding operation and thus prevents the penetration of contamination and spatters during the welding operation on the customer's premises. In this way, it is possible to carry out the further processing of rolling bearing assembly 1 and also to deliver rolling bearing assembly 1, including rotor shaft 20 and bearing 10, together with the turbine housing, to the customer.

### LIST OF REFERENCE NUMERALS

1 rolling bearing assembly

2 first outer ring

3 second outer ring

4 first cage

5 second cage

6 claw-shaped formation

7 rolling element

8 gap

10 bearing

11 outer raceway

15 friction bearing

20 rotor shaft

21 first inner raceway

22 second inner raceway

23 heat choke groove

25 area

26 end of rotor shaft

30 securing element

31 tab

35 clearance

A axis

1-10. (canceled)

11. A rolling bearing assembly for turbochargers, comprising:
a bearing and a rotor shaft, a first inner raceway and a second inner raceway for the bearing being provided in the rotor shaft;
a first cage and a second cage for accommodating rolling elements; and
a first outer ring and a second outer ring, each including an outer raceway,
a claw-shaped formation being provided on the first outer ring and on the second outer ring, the claw-shaped formation holding the first outer ring and the second outer ring against each other in a form-fitting manner.

12. The rolling bearing assembly as recited in claim 11 wherein a clearance is open in the direction of the rotor shaft and is provided in the assembled state of the bearing, due to the claw-shaped formation of the first outer ring and the second outer ring.

13. The rolling bearing assembly as recited in claim 11 further comprising a securing element mounted in a gap between the first outer ring and the second outer ring, whereby bearing play and a position of the first outer ring and the second outer ring are adjustable with respect to each other in the direction of an axis of the rotor shaft.

14. The rolling bearing assembly as recited in claim 13 wherein the securing element connects the first outer ring and the second outer ring in a form-fitting manner.

15. The rolling bearing assembly as recited in claim 13 wherein the securing element is provided with a tab.

16. The rolling bearing assembly as recited in claim 13 wherein the securing element is manufactured from sheet metal.

17. The rolling bearing assembly as recited in claim 13 wherein the rotor shaft includes a heat choke groove.

18. A method for installing a rolling bearing assembly, the method comprising the following steps:
mounting a first cage including rolling elements onto a first inner raceway provided in a rotor shaft;
installing a first outer ring in such a way that the rolling elements of the first cage interact with the first inner raceway and an outer raceway of the first outer ring;
installing a second outer ring on the rotor shaft, the first outer ring and the second outer ring partially meshing with each other axially;
mounting a second cage including further rolling elements onto a second inner raceway provided in the rotor shaft;
pulling out and rotating the second outer ring with respect to the first outer ring, so that claw-shaped formations of the first outer ring and the second outer ring connect the first and second outer ring in a form-fitting manner.

19. The method as recited in claim 18 further comprising a securing element mounted in a gap between the first outer ring and the second outer ring.

20. The method as recited in claim 19 wherein a bearing play and the position of the first outer ring and the second outer ring are adjusted with respect to each other in the direction of an axis of the rotor shaft with the aid of the securing element.
